(19) United States
(12) Patent Application Publication
(10) Pub. No.: US 2018/0179365 A1
(43) Pub. Date: Jun. 28, 2018

(54) METHOD FOR PRODUCING WET RUBBER MASTERBATCH

(71) Applicant: TOYO TIRE & RUBBER CO., LTD., Itami-shi (JP)

(72) Inventor: Yuya Konno, Itami-shi (JP)

(73) Assignee: TOYO TIRE & RUBBER CO., LTD., Itami-shi (JP)

(21) Appl. No.: 15/806,602

(22) Filed: Nov. 8, 2017

(30) Foreign Application Priority Data
Dec. 28, 2016 (JP) 2016-256603

(51) Int. Cl. C08L 9/06

(52) U.S. Cl. CPC C08L 9/06; C08L 2310/00

(57) ABSTRACT

A method for producing a wet rubber masterbatch, comprising a step (I) of adding, at the time of dispersing the filler into the dispersing solvent, at least one portion of the synthetic styrene butadiene rubber latex solution into the dispersing solvent to produce a slurry solution comprising the filler to which rubber latex particles adhere, a step (II) of mixing the slurry solution with the rest of the rubber latex solution to produce a filler-containing rubber latex solution in which the rubber latex particles adhere to the filler, a step (III) of solidifying the filler-containing rubber latex solution, in which the rubber latex particles adhere to the filler, to produce a rubber solidified product, and a step (IV) of dehydrating and drying the rubber solidified product, wherein in anyone of the steps (I) to (IV), the rubber powder is mixed with the wet-rubber-masterbatch-producing phase present in the step.

### BACKGROUND OF THE INVENTION

### Field of the Invention

The present invention relates to a method for producing a wet rubber masterbatch, using, as raw materials, at least a rubber powder, a filler, a dispersing solvent, and a synthetic styrene butadiene rubber latex solution.

### Description of the Related Art

Rubber product wastes, such as waste tires, have been conventionally reused, and have been used, for example, as fuels in cement factories and others. In recent years, under the consideration of environmental problems, material recycle is recommended, in which waste tires and the like are pulverized and the resultant is used, as it is, as rubber pieces or rubber powder. However, there has been caused a problem that when rubber powder obtained by pulverizing waste tires and the like into fine powder is blended into a new rubber, a vulcanized rubber yielded by vulcanizing the rubber composition is deteriorated in physical properties, for example, abrasion resistance and bending fatigue resistance.

Apart from the above, it has been conventionally known that when a rubber composition containing a filler, such as carbon black, is produced in the rubber industry, a wet rubber masterbatch is used to improve the composition in workability and the filler in dispersibility in the composition. This manner is a manner of: mixing a filler and a dispersing solvent beforehand with each other at a predetermined ratio; dispersing the filler into the dispersing solvent by mechanical force to prepare a filler-containing slurry solution; mixing this slurry solution with a rubber latex solution in a liquid phase; adding, to the liquid phase, a coagulant such as an acid to produce a solidified product; and then collecting and drying the product. The use of the wet rubber masterbatch can give a rubber composition better in rubber physical properties and filler-dispersing performance than the use of dry rubber masterbatches each yielded by mixing a filler with a rubber in a solid phase.

For example, Patent Document 1 listed below describes a wet rubber masterbatch composition yielded by: blending a phenolic resin and/or an alicyclic hydrocarbon resin into a wet rubber masterbatch yielded by mixing a rubber-component-including rubber liquid with a slurry solution in which a filler and/or at least one inorganic filler is/are beforehand dispersed in water; and then solidifying, dehydrating and drying the resultant mixture. Patent Document 2 listed below describes a rubber composition which is composed of a rubber component including a diene rubber, and a filler, and which has dc, di and ϕi satisfying a specified relational expression in which dc represents the actual density of the composition that is gained by the method A in JIS K6268, and di and ϕi represent the density of any component “i” in the composition and the proportion by mass thereof, respectively, the density and the proportion being according to constituent-component analysis of the composition.

Patent Document 3 listed below describes a rubber composition for treads that includes a wet rubber masterbatch yielded by mixing a rubber latex, a filler-dispersed liquid, and a liquid diene-based polymer emulsion with each other. Furthermore, Patent Document 4 listed below describes a rubber composition for tires that includes a wet masterbatch yielded by mixing a rubber latex with a dispersion liquid of an electroconductive carbon black having a nitrogen adsorption specific surface area of 900 m²/g or more, and a DBP oil absorption amount of 300 mL/100-g or more.

### PRIOR ART DOCUMENTS

### Patent Documents

Patent Document 1: JP-A-2006-342262

Patent Document 2: JP-A1-2010-123072

Patent Document 3: JP-A-2012-102238

Patent Document 4: JP-A-2015-34280

However, the above-mentioned documents never describe nor suggest that a rubber powder is blended into a rubber composition.

In the light of the actual situation, the present invention has been made, and an object thereof is to provide a method for producing a wet rubber masterbatch which includes an evenly dispersed rubber powder and can prevent a deterioration of the resultant vulcanized rubber in abrasion resistance and bending fatigue resistance, this deterioration caused by the blend of the rubber powder.

### SUMMARY OF THE INVENTION

The object can be attained by the present invention, which is a method for producing a wet rubber masterbatch, using, as raw materials, at least a rubber powder, a filler, a dispersing solvent, and a synthetic styrene butadiene rubber latex solution, including: a step (I) of adding, at the time of dispersing the filler into the dispersing solvent, at least one portion of the synthetic styrene butadiene rubber latex solution into the dispersing solvent to produce a slurry solution containing the filler to which rubber latex particles adhere; a step (II) of mixing the slurry solution with the rest of the rubber latex solution to produce a filler-containing rubber latex solution in which the rubber latex particles adhere to the filler; a step (III) of solidifying the filler-containing rubber latex solution, in which the rubber latex particles adhere to the filler, to produce a rubber solidified product; and a step (IV) of dehydrating and drying the rubber solidified product; wherein in any one of the steps (I) to (IV), the rubber powder is mixed with the wet-rubber-masterbatch-producing phase present in the step.

According to the producing method, when a filler is dispersed into a dispersing solvent, at least one portion of a synthetic styrene butadiene rubber latex solution is added into the dispersing solvent to produce a slurry solution containing the filler to which rubber latex particles adhere (step (I)). In this way, a very thin latex phase is generated onto a partial or entire surface of the filler; thus, when the slurry solution is mixed with the rest of the rubber latex solution in the step (II), the filler can be prevented from being re-aggregated, and also in the step (III) of solidifying and drying the resultant filler-containing rubber latex solution, in which rubber latex particles adhere to the filler, the filler can be restrained from being re-aggregated. As a result, a wet rubber masterbatch can be produced in which the filler is evenly dispersed and the dispersion stability of the filler is excellent also over time. Furthermore, according to the producing method, in any one of the steps (I) to (IV), a rubber powder is blended into the wet-rubber-masterbatch-producing phase present in the step. In this way, the wet rubber masterbatch can be produced as a masterbatch which can prevent a deterioration of the resultant vulcanized rubber in abrasion resistance and bending fatigue resistance, this deterioration caused by the blend of the rubber powder.

Additionally, the method for producing a rubber composition according to the present invention is a method for producing a rubber composition including a wet rubber masterbatch, wherein the wet rubber masterbatch is produced by the above-defined producing method.

### DETAILED DESCRIPTION OF THE PREFERRED EMBODIMENTS

According to the present invention, a wet rubber masterbatch is yielded by adding, at the time of dispersing a filler into a dispersing solvent, at least one portion of a synthetic styrene butadiene rubber latex solution into the dispersing solvent to produce a slurry solution containing the filler to which rubber latex particles adhere (step (I)); mixing the slurry solution with the rest of the rubber latex solution (step (II)); and then the resultant is solidified, dehydrated, and dried (steps (III) to (IV)). Furthermore, in any one of the steps (I) to (IV), a rubber powder is mixed with the wet-rubber-masterbatch-producing phase present in the step.

In the present invention, the rubber powder is preferably a rubber powder which has been at least partially vulcanized. In the case of considering, particularly, environmental problems, the rubber powder is preferably a rubber powder yielded by making a regenerated rubber into powder, this regenerated rubber being yielded by the use of used tires as raw material. In the case of considering the tensile strength and the tearing strength of the resultant vulcanized rubber, and the workability of the resultant tire member, the particle size of the rubber powder is preferably 100 mesh or less, more preferably 200 mesh or less, the words “mesh” herein being according to ASTM D5644-01.

In the present invention, the filler means an inorganic filler used ordinarily in the rubber industry, such as carbon black, silica, clay, talc, calcium carbonate, magnesium carbonate, or aluminum hydroxide. In the present invention, out of these inorganic fillers, carbon black is in particular preferably usable.

The species of the carbon black may be any carbon black species used in an ordinary rubber industry, such as SAF, ISAF, HAF, FEF or GPF, or may be an electroconductive carbon black species such as acetylene black or ketjen black. The form of the carbon black species may be a granulated carbon black species, which has been granulated, considering the handleability thereof in an ordinary rubber industry; or may be a non-granulated carbon black species.

The dispersing solvent is in particular preferably water, and may be, for example, water containing an organic solvent.

In the present invention, the synthetic styrene butadiene rubber latex solution is used as a rubber latex solution. The synthetic styrene butadiene rubber latex solution may be a synthetic styrene butadiene rubber latex solution in which such a rubber synthesized by emulsion polymerization or solution polymerization is or has been emulsified or dispersed in water. The rubber component (rubber polymer) content in the latex is not particularly limited, and is generally from 10 to 60% by mass.

In the present invention, besides the synthetic styrene butadiene rubber latex solution, for example, a natural rubber latex solution is usable as another rubber latex solution. The natural rubber latex solution is a natural product obtained by metabolic effect of a plant. Particularly preferred is a natural-rubber/aqueous latex solution in which a dispersing solvent is water. About a natural rubber in the natural rubber latex used in the present invention, the average molecular weight thereof is preferably 2000000 or more, more preferably 2500000 or more. About the natural rubber latex, concentrated latex, fresh latex named field latex, and other latexes are usable without being distinguished from each other. It is however more preferred that the content of the rubber latex solution other than the synthetic styrene butadiene rubber latex solution is smaller. Specifically, the blend proportion of the synthetic styrene butadiene rubber latex solution is set preferably to 95% by mass or more, more preferably to 98% by mass or more of the whole of (the solid in) the rubber latex solution.

Hereinafter, a description will be made about the method for producing a wet rubber masterbatch according to the present invention. In the present embodiment, a description will be made, particularly, about an example using carbon black as the filler.

This producing method includes a step (I) of adding, at the time of dispersing carbon black into a dispersing solvent, at least one portion of a synthetic styrene butadiene rubber latex solution into the dispersing solvent to produce a slurry solution containing the carbon black to which rubber latex particles adhere; a step (II) of mixing the slurry solution with the rest of the synthetic styrene butadiene rubber latex solution to produce a carbon-black-containing rubber latex solution in which the rubber latex particles adhere to the carbon black; a step (III) of solidifying the carbon-black-containing rubber latex solution, in which the rubber latex particles adhere to the carbon black, to produce a rubber solidified product; and a step (IV) of dehydrating and drying the rubber solidified product.

### (1) Step (I)

In the step (I), at the time of dispersing carbon black into a dispersing solvent, at least one portion of a synthetic styrene butadiene rubber latex solution is added to the dispersing solvent to produce a slurry solution containing the carbon black to which rubber latex particles adhere. It is allowable to mix the synthetic styrene butadiene rubber latex solution beforehand with the dispersing solvent, and then add the carbon black to the mixture to disperse the carbon black in the mixture. It is also allowable to: add the carbon black to the dispersing solvent; and then add the synthetic styrene butadiene rubber latex solution thereto at a predetermined adding-speed and simultaneously disperse the carbon black in the dispersing solvent. Alternatively, it is allowable to: add the carbon black to the dispersing solvent; and next add thereto a predetermined volume of the synthetic styrene butadiene rubber latex solution several times through operations separated from each other and simultaneously disperse the carbon black in the dispersing solvent. By dispersing the carbon black into the dispersing solvent in the presence of the synthetic styrene butadiene rubber latex solution, the slurry solution can be produced, which contains the carbon black to which the rubber latex particles adhere. The addition amount of the synthetic styrene butadiene rubber latex solution in the step (I) is, for example, from 0.5 to 50% by mass of the whole of the synthetic styrene butadiene rubber latex solution to be used (the whole of fractions of this latex solution that are to be added in the step (I) and in the step (II)).

In the step (I)), the solid (rubber) content in the synthetic styrene butadiene rubber latex solution to be added is preferably from 0.5 to 10%, more preferably from 1 to 6% by mass of the carbon black. The concentration of the solid (rubber) in the synthetic styrene butadiene rubber latex solution to be added is preferably from 0.5 to 5% by mass, more preferably from 0.5 to 1.5% by mass. In these cases, a wet rubber masterbatch can be produced in which the dispersion degree of the carbon black is heightened while the rubber latex particles are surely caused to adhere to the carbon black.

In the step (I), the method for mixing the carbon black and the dispersing solvent with each other in the presence of the synthetic styrene butadiene rubber latex solution is, for example, a method of dispersing the carbon black, using an ordinary dispersing machine such as a highly shearing mixer, a High Shear Mixer, a homo-mixer, a ball mill, a bead mill, a high-pressure homogenizer, an ultrasonic homogenizer or a colloid mill.

The “highly shearing mixer” means a mixer having a high-speed-rotatable rotor and a fixed stator in which in the state of making a precise clearance between the rotor and the stator, the rotor is rotated so that a highly shearing effect acts. In order to produce such a highly shearing effect, it is preferred to set the clearance between the rotor and the stator to 0.8 nm or less, and set the circumferential speed of the rotor to 5 m/s or more. Such a highly shearing mixer may be a commercially available product. An example thereof is a mixer, “High Shear Mixer”, manufactured by Silverson.

In the present invention, at the time of mixing the carbon black with the dispersing solvent in the presence of the synthetic styrene butadiene rubber latex solution to produce the slurry solution, which contains the carbon black to which the rubber latex particles adhere, a surfactant may be added thereto in order to improve the carbon black in dispersibility. The surfactant may be a surfactant known in the rubber industry. Examples thereof include nonionic surfactants, anionic surfactants, cationic surfactants, and amphoteric surfactants. Instead of the surfactant or in addition to the surfactant, an alcohol such as ethanol maybe used. However, when the surfactant is used, it is feared that the finally obtained vulcanized rubber is lowered in rubber physical properties. Thus, the blend amount of the surfactant is preferably 2 parts by mass or less, more preferably 1 part by mass or less for 100 parts by mass of the solid (rubber) in the synthetic styrene butadiene rubber latex solution. It is preferred not to use any surfactant substantially.

### (2) Step (II)

In the step (II), the slurry solution is mixed with the rest of the synthetic styrene butadiene rubber latex solution to produce a carbon-black-containing rubber latex solution in which the rubber latex particles adhere to the carbon black. The method for mixing the slurry solution with the rest of the synthetic styrene butadiene rubber latex solution in a liquid phase is not particularly limited, and may be a method of mixing the slurry solution with the rest of the synthetic styrene butadiene rubber latex solution, using an ordinary dispersing machine such as a highly shearing mixer, a High Shear Mixer, a homo-mixer, a ball mill, a bead mill, a high-pressure homogenizer, an ultrasonic homogenizer or a colloid mill. At the time of mixing, the whole of the mixing system, for example, the dispersing machine may be optionally heated.

Considering the drying period and labor in the subsequent step (IV), the solid (rubber) concentration in the rest of the synthetic styrene butadiene rubber latex solution is preferably higher than that in the synthetic styrene butadiene rubber latex solution added in the step (I). Specifically, the former solid (rubber) concentration is preferably from 10 to 60% by mass, more preferably from 20 to 30% by mass.

### (3) Step (III)

In the step (III), the carbon-black-containing rubber latex solution is solidified, in which the rubber latex particles adhere to the carbon black. The method for the solidification is, for example, a method of incorporating a coagulant into the carbon-black-containing rubber latex solution, in which the natural rubber latex particles adhere to the carbon black.

The coagulant to be used may be, acid such as formic acid and sulfuric acid, or salt such as sodium chloride, that are usually used to solidify a rubber latex solution.

### (4) Step (IV)

In the step (IV), the resultant rubber solidified product is dehydrated and dried. The method for the drying may be a method using a drying machine that may be of various types, such as an oven, a vacuum drier, or an air drier.

In any one of the steps (I) to (IV) in the method according to the present invention for producing a wet rubber masterbatch, a rubber powder is mixed with the wet-rubber-masterbatch-producing phase present in the step. When the rubber-powder-mixing step is the step (I), the mixing of the rubber powder may be performed, for example, when the filler is dispersed into the dispersing solvent, or at a timing before or after the addition of the synthetic styrene butadiene rubber latex solution or at the same timing of the addition. When the rubber-powder-mixing step is the step (II), the mixing of the rubber powder may be performed, for example, at a timing before or after the addition of the rest of the rubber latex solution, or at the same timing of the addition. When the rubber-powder-mixing step is the step (III), the mixing of the rubber powder may be performed, for example, at a timing before or after the addition of the coagulant, or at the same timing of the addition. When the rubber-powder-mixing step is the step (IV), the mixing of the rubber powder maybe performed, for example, at any timing in the dehydrating stage or the drying stage.

In the wet rubber masterbatch that has been obtained after the step (IV), the rubber powder is included preferably in an amount of 1 to 40 parts by mass for 100 parts by mass of the rubber. In this case, the rubber powder is evenly dispersed in the wet rubber masterbatch, and thus this masterbatch can be a raw material for vulcanized rubbers excellent in abrasion resistance and bending fatigue resistance.

In the wet rubber masterbatch that has been obtained after the step (IV), the filler is included preferably in an amount of 70 parts by mass or less for 100 parts by mass of the rubber. In this case, a wet rubber masterbatch improved in filler-dispersing degree can be produced which can give a vulcanized rubber improved in low exothermicity and endurance, the filler-dispersing degree improvement and the other improvements being made with a good balance.

One or more blending agents used ordinarily in the rubber industry are optionally incorporated into the wet rubber masterbatch that has been obtained after the step (IV) to make it possible to produce a rubber composition according to the method of the present invention. Examples of these agents include a sulfur-containing vulcanizing agent, a vulcanization accelerator, silica, a silane coupling agent, zinc oxide, stearic acid, a vulcanization accelerator aid, a vulcanization retardant, an organic peroxide, an antiaging agent, softeners such as waxes and oils, and a processing aid.

The species of sulfur in the sulfur-containing vulcanizing agent may be any ordinary sulfur species for rubbers. Examples thereof include powdery sulfur, precipitated sulfur, insoluble sulfur, and highly dispersible sulfur. The sulfur content in the rubber composition according to the method of the present invention for tire rubbers is preferably from 0.3 to 6.0 parts by mass for 100 parts by mass of the rubber component. If the sulfur content is less than 0.3 part by mass, the resultant vulcanized rubber is short in crosslinkage density to be lowered in rubber strength and others. If the content is more than 6.0 parts by mass, the rubber is deteriorated, particularly, in both of heat resistance and durability. In order to keep the rubber strength of the vulcanized rubber good certainly and further improve the heat resistance and the durability, the sulfur content is set into a range more preferably from 1.0 to 4.5 parts by mass, even more preferably from 1.4 to 2.8 parts by mass for 100 parts by mass of the rubber component.

The vulcanization accelerator may be a vulcanization accelerator usable ordinarily for vulcanizing rubbers. Examples thereof include sulfenamide type, thiuram type, thiazole type, thiourea type, guanidine type, and dithiocarbamate type vulcanization accelerators. These maybe used singly or in the form of an appropriate mixture. The vulcanization accelerator content is more preferably from 1.0 to 5.0 parts by mass, even more preferably from 1.5 to 4.0 parts by mass for 100 parts by mass of the rubber component.

The antiaging agent may be an antiaging agent usable usually for rubbers. Examples thereof include aromatic amine type, amine-ketone type, monophenolic type, bisphenolic type, polyphenolic type, dithiocarbamate type, and thiourea type antiaging agents. These may be used singly or in the form of an appropriate mixture. The antiaging agent content is more preferably from 0.3 to 3.0 parts by mass, even more preferably from 0.5 to 2.0 parts by mass for 100 parts by mass of the rubber component.

The rubber composition according to the method of the present invention can be obtained by using a mixing machine used in an ordinary rubber industry, such as a Bunbury mixer, a kneader or a roll, to mix the wet rubber masterbatch with components that may be optionally used, and then kneading the mixture, examples of the optional components including a sulfur-containing vulcanizing agent, a vulcanization accelerator, silica, a silane coupling agent, zinc oxide, stearic acid, a vulcanization accelerator aid, a vulcanization retardant, an organic peroxide, an antiaging agent, softeners such as wax and oil, a processing aid.

The method for blending each component with each other is not particularly limited, and may be any one of a method of kneading, in advance, the components other than the vulcanization-related components such as the sulfur-containing vulcanizing agent and the vulcanization accelerator to prepare a masterbatch, adding the remaining components thereto, and further kneading the entire components; a method of adding each component in any order to a kneading machine, and kneading the components; a method of adding, to the same machine, the entire components simultaneously, and kneading the components; and other methods.

### EXAMPLES

Hereinafter, this invention will be more specifically described by demonstrating examples thereof. Raw materials used therein are as follows.

### (Used Raw Materials)

a) Rubber Components

ESBR (emulsion-polymerized styrene butadiene rubber): “SBR 1502” manufactured by JSR Corporation (Mw: 420000)

Synthesized styrene butadiene rubber latex solution (SBR latex): “ROADEX” manufactured by JSR Corporation (solid content: 50%; Tg: −50° C.)
b) Filler (carbon black (CB)); “SEAST KH” manufactured by Tokai Carbon Co., Ltd. (N2SA: 93 m²/g,; DBP: 119 cm³/100-g)
c) Zinc flower; “Zinc Flower No. 1” manufactured by Mitsui Mining & Smelting Co., Ltd.
d) Antiaging agent; “NOCRAC 6C” manufactured by Ouchi Shinko Chemical Industrial Co., Ltd.
(N-(1,3)-dimethylbutyl) -N′-phenyl-p-phenylenediamine, 6PPD)
e) Stearic acid; “LUNAC S20” manufactured by Kao Corporation
f) Rubber powders

Rubber powder 1 (PD 140) ; “PolyDyne 140” manufactured by Lehigh Technologies, Inc. (in accordance with ASTM D 5644-01, 120 mesh (125 μm); <1 (% Retained), 140 mesh (105 μm); <10 (% Retained), Minus 200 mesh (75 μm); >30% (Retained))

Rubber powder 2 (PD 200); “PolyDyne 200” manufactured by Lehigh Technologies, Inc. (in accordance with ASTM D 5644-01, 170 mesh (88 μm); <1 (% Retained), 200 mesh (74 μm); <10 (% Retained))
g) Sulfur: “Powdery Sulfur” manufactured by Tsurumi Chemical Industry Co., Ltd.
h) Vulcanization accelerator: “SOXINOL CZ” manufactured by Sumitomo Chemical Co., Ltd.

### (Evaluations)

Evaluations were made about a rubber yielded by using a predetermined mold to heat and vulcanize a rubber composition of each of Examples and Comparative Examples described below at 150° C. for 30 minutes.

### (Abrasion Resistance of Vulcanized Rubber)

A Lambourn abrasion tester manufactured by Iwamoto Seisaku-sho Co., Ltd. is used to measure the abrasion loss of the vulcanized rubber at a load of 40 N, a slip ratio of 30%, a temperature of 23° C., and a sand-dropping rate of 20 g/minute in accordance with JIS K6264. About each of the examples, the measured value is represented as an index relative to the value of Comparative Example 1, this value being regarded as 100. It is meant that as the resultant index is larger, the vulcanized rubber is smaller in abrasion amount to be better in abrasion resistance.

### (Fatigue Resistance of Vulcanized Rubber)

In accordance with JIS K6260, the measurement of the vulcanized rubber is made at a temperature of 23° C. The rubber is flexed until the resultant crack grows to reach into a size of 2 mm. The number of times of the flexing is gained. About each of the examples, the measured value is represented as an index relative to the value of Comparative Example 1, this value being regarded as 100. It is meant that as the resultant index is larger, the rubber composition is better in fatigue resistance.

### Example 1

Into a dilute SBR latex aqueous solution (solid (rubber) content: 0.8 part by mass) having an adjusted concentration of 0.5% by mass were added 50 parts by mass of carbon black and 20 parts by mass of rubber powder 1. A ROBOMIX manufactured by PRIMIX Corporation was used (ROBOMIX conditions: 9000 rpm for 30 minutes) to disperse the carbon black into this liquid phase to produce a carbon-black-containing slurry solution in which rubber latex particles adhered to the carbon black (step (I)).

Next, to the carbon-black-containing slurry solution produced in the step (I), in which the rubber latex particles adhered to the carbon black, was added the rest of the rubber latex solution (having a solid (rubber) concentration of 25% by mass, this concentration being adjusted by the addition of water) to set the total solid (rubber) amount in the rest of the rubber latex solution, and the natural rubber latex solution used in the step (I) into 100 parts by mass. Next, a mixer for home use, SM-L56 model, manufactured by SANYO Electric Co., Ltd. was used to mix each component with each other (mixer conditions: 11300 rpm for 30 minutes) to produce a carbon-black-containing rubber latex solution (step (II)).

To the carbon-black-containing rubber latex solution produced in the step (II) was added a 10% by mass aqueous solution of formic acid, as a coagulant, until the pH of the latex solution turned to 4. A screw press, V-01 model, manufactured by SUEHIRO EPM Corporation was used to dry the resultant solidified product into a water proportion of 1.5% or less. In this way, a wet rubber masterbatch (WMB 2) was produced (steps (III) and (IV)).

Various additives shown in Table 1 were blended into the resultant wet rubber masterbatch to produce a rubber composition. Physical properties of a vulcanized rubber of the composition were measured. The results are shown in Table 1.

### Example 2

A wet rubber masterbatch (WMB 2) and a vulcanized rubber were produced in the same way as in Example 1 except that instead of the addition of the rubber powder in the step (I), in the step (II) the rubber powder was added to the wet-rubber-masterbatch-producing phase at the same time of adding the rest of the rubber latex solution thereto.

### Example 3

A wet rubber masterbatch (WMB 2) and a vulcanized rubber were produced in the same way as in Example 1 except that instead of the addition of the rubber powder in the step (I), in the step (III) the rubber powder was added to the wet-rubber-masterbatch-producing phase at the same time of adding formic acid thereto.

### Example 4

A wet rubber masterbatch (WMB 3) and a vulcanized rubber were produced in the same way as in Example 1 except that instead of the addition of the rubber powder in the step (I), in the step (III) rubber powder 2 was added to the wet-rubber-masterbatch-producing phase at the same time of adding formic acid thereto.

### Comparative Examples 1 to 3

In Comparative Example 1, ESBR and various blending agents were mixed/kneaded under dry conditions to produce a rubber composition. In each of Comparative Examples 2 and 3, ESBR, a rubber powder, and various blending agents were mixed/kneaded under dry conditions to produce a rubber composition.

### Comparative Example 4

Under dry conditions, a rubber powder was mixed with a wet rubber masterbatch (WMB1) shown in Table 1, and the mixture was kneaded to produce a rubber composition.

TABLE 1

| | Comparative | Comparative | Comparative | Comparative | Example | Example | Example | Example |
|---|---|---|---|---|---|---|---|---|
| Blending agent | Example 1 | Example 2 | Example 3 | Example 4 | 1 | 2 | 3 | 4 |
| ESBR | 100 | 100 | 1.00 | | | | | |
| WMB1 | | | | 150 | | | | |
| (SBR latex/CB) | | | | (100/50) | | | | |
| WMB2 | | | | | 170 | 170 | 1.70 | |
| (SBR latex/CB/PD140) | | | | | (100/50/20) | (100/50/20) | (100/50/20) | |
| WMB3 | | | | | | | | 170 |
| (SBR latex/CB/PD200) | | | | | | | | (100/50/20) |
| Carbon black | 50 | 50 | 50 | | | | | |
| Rubber-powder- | — | — | — | — | Step (I) | Step (II) | Step (III) | Step (III) |
| adding timing | | | | | | | | |
| Zinc flower | 3 | 3 | 3 | 3 | 3 | 3 | 3 | 3 |
| Antiaging agent | 2 | 2 | 2 | 2 | 2 | 2 | 2 | 2 |
| Stearic acid | 2 | 2 | 2 | 2 | 2 | 2 | 2 | 2 |
| Wax | 2 | 2 | 2 | 2 | 2 | 2 | 2 | 2 |
| PD140 | | 20 | | 20 | | | | |
| PD200 | | | 20 | | | | | |
| Sulfur | 2 | 2 | 2 | 2 | 2 | 2 | 2 | 2 |
| Vulcanization | 2 | 2 | 2 | 2 | 2 | 2 | 2 | 2 |
| accelerator | | | | | | | | |
| Rolling resistance | 100 | 110 | 89 | 99 | | | | |
| Abrasion | 100 | 85 | 92 | 95 | 102 | 100 | 100 | 105 |
| Fatigue resistance | 100 | 88 | 90 | 96 | 103 | 102 | 100 | 104 |

What is claimed is:

1. A method for producing a wet rubber masterbatch, using, as raw materials, at least a rubber powder, a filler, a dispersing solvent, and a synthetic styrene butadiene rubber latex solution, comprising:
a step (I) of adding, at the time of dispersing the filler into the dispersing solvent, at least one portion of the synthetic styrene butadiene rubber latex solution into the dispersing solvent to produce a slurry solution comprising the filler to which rubber latex particles adhere,
a step (II) of mixing the slurry solution with the rest of the rubber latex solution to produce a filler-containing rubber latex solution in which the rubber latex particles adhere to the filler,
a step (III) of solidifying the filler-containing rubber latex solution, in which the rubber latex particles adhere to the filler, to produce a rubber solidified product, and a step (IV) of dehydrating and drying the rubber solidified product,
wherein in any one of the steps (I) to (IV), the rubber powder is mixed with the wet-rubber-masterbatch-producing phase present in the step.

2. A method for producing a rubber composition comprising a wet rubber masterbatch,
wherein the wet rubber masterbatch is produced by the producing method recited in claim 1.
